(19) United States
(12) Patent Application Publication
(10) Pub. No.: US 2005/0177347 A1
(43) Pub. Date: Aug. 11, 2005

(54) Manufacturing device with automatic remote monitoring and a corresponding monitoring method

(76) Inventors: Volker Maier, Ostfildern (DE); Rudolf Walter, Solothurn (CH)

Correspondence Address: WHITE & CASE LLP;PATENT DEPARTMENT, 1155 AVENUE OF THE AMERICAS, NEW YORK, NY, 10036, US

(21) Appl. No.: 10/949,499

(22) Filed: Sep. 24, 2004

(30) Foreign Application Priority Data
Sep. 30, 2003 (DE) 10345883.2

(51) Int. Cl. G06F 19/00

(52) U.S. Cl. 702/188; 700/108

(57) ABSTRACT

It is to be possible to monitor manufacturing devices, in particular main spindles (1), centrally and securely. For this purpose it is provided that the respective main spindle (1) transmits operating and status data to a monitoring organization (2) over the Internet (3) for example. The data can be monitored there on the basis of limit values for example. Manufacturers (4) and OEMs (5) are preferably automatically notified if limit values are exceeded. The transmission of the operating data to the central monitoring organization (2) does not take up any of the machine's own resources for status monitoring and the manufacturers (4) are notified only if necessary. The active sending of the data from the manufacturing device or main spindle unit (1) to the monitoring organization (2) increases data security.

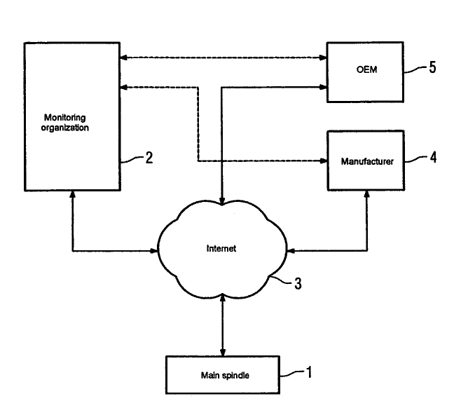

The present invention relates to a manufacturing device having a sensor means for providing operating data of the manufacturing device and a data processing means for processing the operating data. The present invention furthermore relates to a manufacturing system having a plurality of such manufacturing devices and a corresponding method for monitoring at least one manufacturing device.

Status monitoring of manufacturing devices and their components has hitherto only been possible by means of locally present monitoring systems and status displays. In such arrangements status attributes are recorded by means of appropriate sensor systems on the manufacturing device or its components and displayed on a locally present display. Maintenance personnel must therefore proceed to the installation site of the machine to determine the status of the manufacturing device. Thus, for instance, status monitoring of a main spindle unit of milling machines, turning machines and the like in machining centers or production lines is usually currently performed by a periodic recording of measured values by means of a sensor system attached to the main spindle unit specifically for this purpose and a portable data acquisition, and possibly evaluation, system. The sensor system usually comprises acceleration pickups and temperature sensors etc. Main spindle units are also known which have an adapted sensor system from the outset and which have installed in or on the machine a measurement data acquisition and evaluation system including visualization unit for the periodic or continuous recording of measured values.

In connection herewith, a spindle having a data storage element for recording operating and status data of the spindle is known from document DE 100 07 126 A1. The data acquisition element supplies the data to a data storage element integrated in the spindle. The data can then be read out by service personnel in connection with malfunctions or warranty claims for instance. The data can be read out by means of a wired system or via a mobile phone for example. Such a remote access mechanism allows the current status of the manufacturing device to be observed remotely for a short time, but not over a longer period of time. It is consequently difficult to identify trends which would indicate, for example, whether a machine was heading toward a critical state. Moreover, said remote access mechanisms are problematical with respect to data security because it is not clearly defined who has access to the data.

In relation to the monitoring of manufacturing devices or their components, there is the further problem that very high data volumes are often produced. This is typically also the case with main spindle units, so that monitoring is associated with a high outlay in terms of time and resources. A summarizing evaluation of a large number of manufacturing devices and their components, which in some circumstances are at locations spread all over the world, is consequently even less feasible. In particular the long-term data acquisition and evaluation of the data is problematic with such high data volumes.

The object of the present invention is thus to enable a long-term monitoring of manufacturing devices and their components with improved security.

According to the invention this object is achieved by a manufacturing device having a sensor means for providing operating data of the manufacturing device and a data processing means for processing the operating data, wherein the data processing means is connected via a remote data connection to a server and is designed for continuous or periodic, self-initiated transmission of the operating data to the server.

A corresponding manufacturing system includes a plurality of such manufacturing devices and a shared server for recording the operating data of the manufacturing devices via at least one remote data connection.

The invention furthermore provides a method for monitoring at least one manufacturing device by providing operating data of the at least one manufacturing device, and continuous or periodic transmission, initiated by the at least one manufacturing device, of the operating data via a remote data connection to a server for processing there.

According to the present invention, rather than selling spindles it is consequently possible, for example, for the manufacturer of the manufacturing device, which may include a machining device or machine tool and in particular a main spindle unit, to sell spindle availability. New operator models such as so-called “pay-on-production” can thus be implemented and can satisfy the ubiquitous demand for intensification of the service efforts of component manufacturers.

The data processing means of the manufacturing device according to the invention preferably includes a memory for local intermediate storage of the operating data. In general the term operating data as used here also includes status data and the like. Intermediate storage is required, for example, for the periodic transmission of the data over the Internet.

An application for monitoring the manufacturing devices is installed on the server, to which the operating data of manufacturing devices and components spread all over the world can be sent. It is thus readily possible to specifically observe the status of a single manufacturing device on the basis of identification information which is likewise sent by every manufacturing device to the server.

Limit values can be defined for the monitoring on the central server by means of a preferably browser-based application. It is thus possible to initiate automatic procedures as soon as the operating or status data of a monitored manufacturing device exceeds the respective limit values.

The manufacturing system according to the invention may furthermore have a communication connection to at least one remote unit, wherein the at least one unit is automatically notified by the server depending on the content or the volume of the operating data or depending on a time value. Such a communication connection can exist for example to the manufacturer of main spindle units so that the latter is automatically notified if the operating data for a main spindle exceeds a given limit value. The notification is expediently performed fully electronically, for example by means of an e-mail. The further advantage of such a central notification system is that the messages do not need to be generated by the individual machines, which would result in an additional load on the machines. In addition, besides the central server, a server operating in parallel is usually provided, so that when required a message will be issued with a high degree of certainty, which would not be the case if a self-notifying machine were to fail.

The present invention will now be described in greater detail with reference to the appended drawing which represents a schematic block circuit diagram of a manufacturing system according to the invention.

The exemplary embodiment described more fully below is a preferred embodiment of the present invention.

According to the invention, a main spindle unit 1 located at an end customer has a communication connection to a server of a monitoring organization 2, as schematically illustrated in the figure. In the chosen embodiment, said communication connection is effected by means of the Internet 3.

During operation the sensor system present in the main spindle unit 1 first of all continuously collects status and operating data signals and stores these locally, possibly preprocessed for forwarding or processing. Said data is transmitted over the Internet 3 to the server of the monitoring organization 2 by means of a software mechanism residing on the automation device belonging to the main spindle unit 1. For security reasons, the main spindle unit 1 transmits the data on its own initiative to the fixed address of the server. This avoids unauthorized third parties being able to externally access the data of the main spindle unit 1. This makes a significant contribution to data security.

For the sake of clarity, only a single main spindle unit 1 is represented in the figure. However, any number of main spindle units or other manufacturing devices or their components can transmit status data to the server of the monitoring organization 2 over the Internet 3. Together with said data, each main spindle unit 1 or other component transmits individual identification information to the server. This enables the operating data to be clearly assigned to the respective machine on the server.

The data of the individual machines can be handled individually on the server using a browser-based application. It is thus possible to define, for example, one or more limit values to be used for monitoring the operating data. For instance a warning limit and a critical limit can be defined. Since a corresponding trend can be identified if necessary by means of the continuous monitoring, if the warning limit is exceeded a message can be generated to the effect that the machine will reach a critical state within the foreseeable future. This enables more effective time and service planning by the company concerned.

If, according to the present exemplary embodiment, one of the limit values is exceeded during the continuous monitoring, a notification is sent fully automatically by the server of the monitoring organization 2 to the manufacturer 4 of the main spindle unit 1 or to an OEM 5 (original equipment manufacturer). The notification can be performed via the Internet 3, for example by e-mail, or else via other communication channels (dotted arrows in the figure). For instance, notification may also be performed via the telephone or via radio.

With the information about limit values being exceeded and the unambiguous identification of the manufacturing system or its components (here the main spindle unit 1), the latter can thus be remotely monitored across organizational boundaries on the basis of the Internet 3. In the event of a notification, the manufacturer 4 or OEM 5 can immediately initiate appropriate servicing measures. This economically creates the basis for selling the availability of the monitored machine or device, since information about the status of the machines, which may be in operation all over the world, is available online.

A notification or a corresponding servicing event can be triggered here by many different causes. Cited here by way of example are the exceeding of a temperature limit value of the main spindle, a so-called crash of the tool with the tool piece during machining, or else also purely routine maintenance intervals. To perform the service, the manufacturer 4 or OEM 5 can directly go to the respective machine and if necessary access the machine in advance via the electronic route, e.g. via the Internet, logging onto the machine using a corresponding code.

1-13. (canceled)

14. A manufacturing device comprising:
a sensor for obtaining data pertaining to the manufacturing device; and
a data processor;
wherein the data processor self initiates the transmission of said data to a remote computer system.

15. The manufacturing device of claim 14 wherein the data is transmitted continuously.

16. The manufacturing device of claim 14 wherein the data is transmitted periodically.

17. The manufacturing device of claim 14 wherein data comprises operating data.

18. The manufacturing device of claim 14 wherein the data comprises status data.

19. The manufacturing device of claim 14 further comprising a main spindle unit.

20. The manufacturing device of claim 14 further comprising a memory which stores the data prior to its transmission.

21. A monitoring system comprising:
a processor;
wherein the processor is configured to receive and store operating data from a plurality of manufacturing devices.

22. The monitoring system of claim 21 further comprising a software application for processing the operating data.

23. The monitoring system of claim 22 wherein the monitoring system communicates with an entity based upon a result of processing the data.

24. The monitoring system of claim 23 wherein the result of processing the data is an indication that a limit value has been exceeded.

25. The monitoring system of claim 23 wherein the entity comprises an operator of one of the plurality of manufacturing devices.

26. The monitoring system of claim 23 wherein the entity comprises a manufacturer of one of the plurality of manufacturing devices.

27. The monitoring system of claim 23 wherein the entity comprises a manufacturer of a component of one of the plurality of manufacturing devices.

28. The monitoring system of claim 23 wherein the entity comprises a service provider.

29. A manufacturing system comprising:
a plurality of manufacturing devices;
a shared server; and
a data connection between the shared server and each of the plurality of manufacturing devices;
wherein each of the plurality of manufacturing devices automatically provides operating data to the shared server over the data connection; and
the shared server records the operating data.

30. A method of monitoring a manufacturing device comprising the steps of:
transmitting operating data of the manufacturing device to a remote processing system;
wherein the transmitting of operating data is initiated by the manufacturing device.

31. The method according to claim 30 wherein the manufacturing device includes a spindle.

32. The method according to claim 30 further comprising the step of temporarily storing the operating data in the manufacturing device.

33. The method according to claim 30 further comprising the step of monitoring the operating data.

34. The method according to claim 33 wherein the monitoring is accomplished by a software application in said remote processing system.

35. The method according to claim 34 wherein the monitoring comprises comparing the data to a limit value.

36. The method according to claim 34 further comprising the step of configuring a monitoring parameter through a browser-based application.

37. The method according to claim 34 further comprising the step of providing information based upon the operating data to an entity that is remote from said remote processing system.

38. The method according to claim 37 wherein the information comprises a notification that the data is outside of a limit value.
